(19) United States
(12) Patent Application Publication
(10) Pub. No.: US 2024/0085913 A1
(43) Pub. Date: Mar. 14, 2024

(54) ROBOT AUTONOMOUS OPERATION METHOD, ROBOT, AND COMPUTER-READABLE STORAGE MEDIUM

(71) Applicant: UBTECH ROBOTICS CORP LTD, Shenzhen (CN)

(72) Inventors: Simin Zhang, Shenzhen (CN); Youjun Xiong, Shenzhen (CN)

(21) Appl. No.: 18/517,006

(22) Filed: Nov. 22, 2023

Related U.S. Application Data
(63) Continuation of application No. PCT/CN2021/125404, filed on Oct. 21, 2021.

(30) Foreign Application Priority Data
May 25, 2021 (CN) 202110571634.2

(51) Int. Cl. G05D 1/02; G01C 21/00; G05D 1/00

(52) U.S. Cl. CPC G05D 1/0212; G01C 21/3841; G05D 1/0011

(57) ABSTRACT

A robot autonomous operation method, a robot, and a computer-readable storage medium are provided. The method includes: moving the robot, under a control of a user, along a guide path in an operation scene; generating a map including the guide path by positioning and mapping during the robot being moved along the guide path in the operation scene; generating a plurality of operation points on the guide path in the map; generating an operation path, wherein the operation path passes through all of the unpassed operation points and has a shortest total distance; and moving the robot, according to the operation path, to each of the unpassed operation points so as to perform an operation. In this manner, it controls the robot to explore the guide path in the operation scene by manual guiding, which can improve the exploration efficiency and reduce the risk of exploring unknown operation scenes.

### CROSS REFERENCE TO RELATED APPLICATIONS

The present disclosure is a continuation-application of International Application PCT/CN2021/125404, with an international filing date of Oct. 21.2021, which claims foreign priority of Chinese Patent Application No. 202110571634.2, filed on May 25, 2021 in the State Intellectual Property Office of China, the contents of all of which are hereby incorporated by reference.

### BACKGROUND

### 1. Technical Field

The present disclosure relates to robot technology, and particularly to a robot autonomous operation method, a robot, and a computer-readable storage medium.

### 2. Description of Related Art

With the continuous development of robot technology, various types of robots such as service robots, entertainment robots, manufacture robots, and agricultural robots have emerged in an endless stream, which bringing great convenience to people's daily life and manufacture activities. At present, robots with autonomous operation functions need to obtain the map of the operation scene by exploring the operation scene before performing autonomous operations, and then navigate according to the planned operation path and map so as to move to the operation scene and perform operations at the operation path.

However, the existing robots cannot determine whether the operation scene has been explored, which resulting in low exploration efficiency, and cannot carry out reasonable operation path planning for unexplored areas, hence low operation efficiency is caused.

### BRIEF DESCRIPTION OF THE DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of a robot autonomous operation method according to a first embodiment of the present disclosure.

FIG. 2 is a flow chart of a robot autonomous operation method according to a second embodiment of the present disclosure.

FIG. 3 is a schematic diagram of transformation relationships between key frames and path points according to an embodiment of the present disclosure.

FIG. 4 is a flow chart of a robot autonomous operation method according to a third embodiment of the present disclosure.

FIG. 5 is a schematic block diagram of the structure of a robot autonomous operation apparatus according to an embodiment of the present disclosure.

FIG. 6 is a schematic block diagram of a robot according to an embodiment of the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the specification and the claims of the present disclosure, the terms “first”, “second”, “third”, and the like in the descriptions are only used for distinguishing, and cannot be understood as indicating or implying relative importance.

References such as “one embodiment” and “some embodiments” in the specification of the present disclosure mean that the particular features, structures or characteristics described in combination with the embodiment(s) are included in one or more embodiments of the present disclosure. Therefore, the sentences “in one embodiment,” “in some embodiments,” “in other embodiments,” “in still other embodiments,” and the like in different places of this specification are not necessarily all refer to the same embodiment, but mean “one or more but not all embodiments” unless specifically emphasized otherwise. The terms “comprising”, “including”, “having” and their variants mean “including but not limited to” unless specifically emphasized otherwise.

A robot autonomous operation method is provided, which can be executed by a processor of a robot when a corresponding computer program is executed. It controls the robot to explore the guide path in the operation scene by manual guiding, which can improve the exploration efficiency and reduce the risk of exploring unknown operation scenes. At the same time, a reasonable operation path planning is performed on the guide path, which can improve the operation efficiency.

In this embodiment, the robot may be any type of robot with autonomous operation functions. Among various types of robots such as service robots, entertainment robots, production robots, and agricultural robots, there are robots with autonomous operation functions, for example sweeping robots, disinfection robots, handling robots, express delivery robots, takeaway robots, etc.

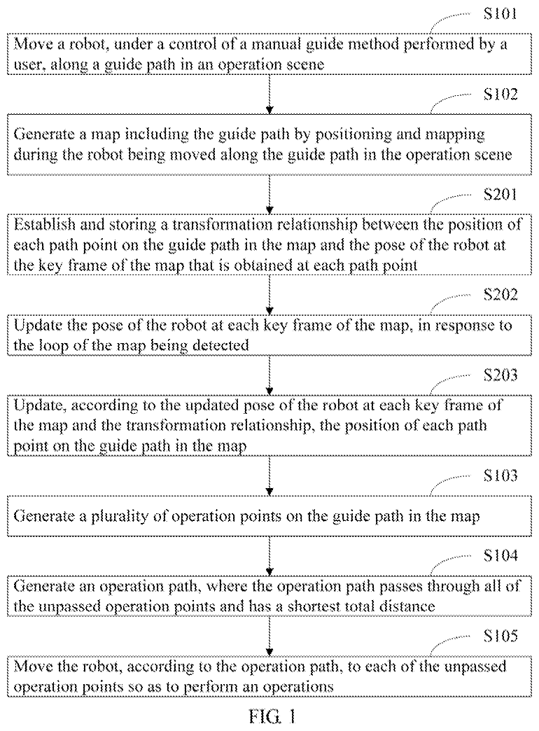

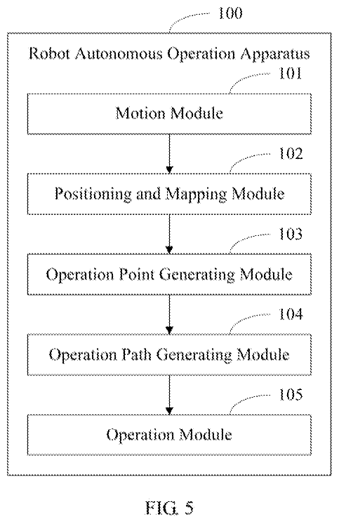

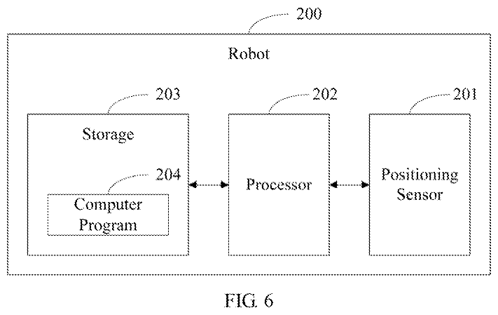

FIG. 1 is a flow chart of a robot autonomous operation method according to a first embodiment of the present disclosure. In this embodiment, a computer-implemented autonomous operation method for the robot is provided. The robot has a positioning sensor. The method may be implemented through a robot autonomous operation apparatus shown in FIG. 5. In other embodiments, the method may be implemented through a robot shown in FIG. 6. As shown in FIG. 1, the autonomous operation method may include the following steps S101-S105.

S101: moving the robot, under a control of a manual guide method performed by a user, along a guide path in an operation scene.

In this embodiment, the user may control the robot to move along the guide path in the operation scene using one of the following three manual guide methods.

First, the user may manually apply force on the robot to pull or push the robot along the guide path in the operation scene.

Second, the user may input motion control instructions through a human-computer interaction equipment of the robot, thereby directly controlling the robot to move along the guide path in the operation scene according to the motion control instructions.

Third, the user may control a user terminal, through a human-computer interaction equipment of the user terminal, to transmit motion control instructions to the robot, thereby indirectly controlling the robot to move along the guide path in the operation scene according to the motion control instructions, where the user terminal can communicate with the robot.

In this embodiment, the human-computer interaction equipment of the robot may include at least one of a physical button, a touch sensor, a gesture recognition sensor, and a voice recognition unit, so that users can input the motion control instructions through corresponding touch methods, gesture control methods, or voice control methods. The physical button and the touch sensor may be disposed anywhere on the robot, for example, a control panel. The touch method for the physical button may be pressing or flipping. The touch method for the touch sensor may be tapping or touching. The gesture recognition sensor may be disposed at any position outside a housing of the robot. The gestures for controlling the robot may be customized by the user according to actual needs or may use the factory default settings. The voice recognition unit may include a microphone and a voice recognition chip, or may only include the microphone and implement a voice recognition function through a processor of the robot. The voice for controlling the robot may be customized by the user according to actual needs or may use the factory default settings.

In this embodiment, the user terminal may be a computing device which have wireless or wired communication functions and can communicatively connect with the robot, for example, a remote control, a mobile phone, a smart bracelet, a tablet, a laptop, a netbook, a personal digital assistant (PDA), a computer, a server, or the like. In this embodiment, the specific type of the user terminal is not limited. The human-computer interaction equipment of the user terminal can be the same as that of the robot, which will not be described again herein.

S102: generating a map including the guide path by positioning and mapping during the robot being moved along the guide path in the operation scene.

In this embodiment, during the robot moves along the guide path in the operation scene, it performs real-time positioning through the positioning sensor, and maps based on the positioning data to generate a map including the guide path. The map should include at least the area where the guide path is located, while other areas besides the guide path may also be included, for example, the areas where other buildings, objects or channels are located besides the guide path. While the robot locates each path point on the guide path in the operation scene and records the position of the path point, it also obtains data (e.g., at least one image or radar data) around the path point and records the pose of the robot at the moment capturing the data. Among the data obtained at each path point, at least one includes a key frame. By establishing the transformation relationship between the position of each path point and the pose corresponding to the key frame that is obtained at the path point, the relationship between the guide path in the map and the map is established, so that when a loop of the map is detected, the position of the path point in the map may be updated based on the pose corresponding to the key frame.

In this embodiment, the robot may include a display screen to directly display a map including the guide path, or the robot may transmit the map to the user terminal so as to indirectly display the map including the guide path through the user terminal.

In one embodiment, step S102 may include:
obtaining, through the positioning sensor of the robot, positioning data during the robot being moved along the guide path in the operation scene, where the positioning sensor includes a dual laser radar; and
generating the map including the guide path by processing the positioning data using a simultaneous localization and mapping technology.

In this embodiment, the robot may obtain the position of each path point by obtaining positioning data through a positioning sensor, processes the positioning data using the simultaneous localization and mapping (SLAM) technology, and positions each path point on the guide path in the operation scene to obtain the location of the path point. At the same time, it may generate a map by mapping based on data such as at least one image obtained at each path point, and eventually the map including the guide path is obtained. The positioning sensor may include a dual lidar, and may also include an infrared sensor, a visual sensor (e.g., a camera), and the like. The dual lidar includes two lidars, where the scanning directions of the two lidars are different and the scanning areas of them partially overlap or complement each other, thereby effectively improving the accuracy of the map generated based on the positioning data obtained by scanning through the dual lidar. The dual lidar may also accurately scan the obstacles or channels on or around the guide path in the operation scene, so that the robot can autonomously avoid the obstacles or cross the channels when performing operations subsequently.

In one embodiment, after step S102, the method may further include:
updating a pose of the robot at each key frame of the map and a position of each path point on the guide path in the map, in response to a loop of the map being detected.

In this embodiment, before the loop of the map is detected, the map and the guide path in the map are at staggered positions. When the loop of the map is detected, the ones in the guide path in the map is first adjusted so that the guide path in the map is adjusted to the correct position, then the ones in the map is adjusted so as to align the data obtained by the robot when passing through the same path point in the operation scene twice before and after, that is, loop of the map, thereby obtaining a map that is consistent with the actual situation, and at the same time the guide path consist with the actual situation is obtained.

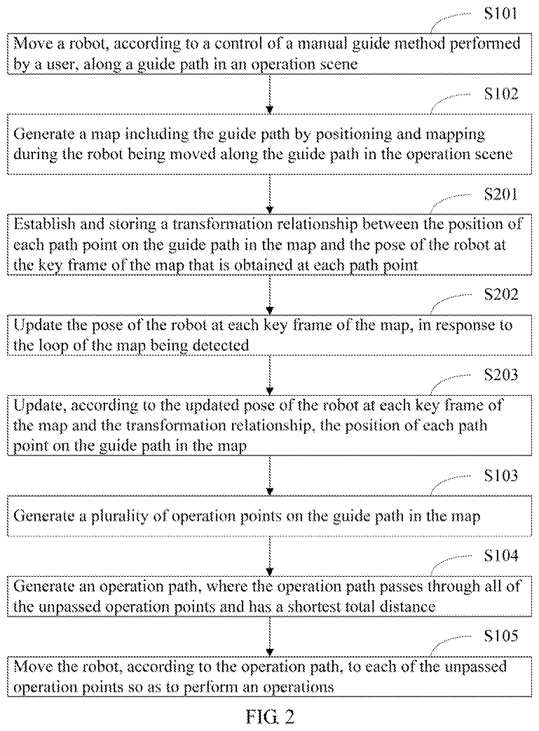

FIG. 2 is a flow chart of a robot autonomous operation method according to a second embodiment of the present disclosure. As shown in FIG. 2, in one embodiment, before updating the pose of the robot at each key frame of the map and the position of each path point on the guide path in the map, in response to the loop of the map being detected, the method may further include:
S201: establishing and storing a transformation relationship between the position of each path point on the guide path in the map and the pose of the robot at the key frame of the map that is obtained at each path point.

The updating the pose of the robot at each key frame of the map and the position of each path point on the guide path in the map, in response to the loop of the map being detected may include:
S202: updating the pose of the robot at each key frame of the map, in response to the loop of the map being detected; and
S203: updating, according to the updated pose of the robot at each key frame of the map and the transformation relationship, the position of each path point on the guide path in the map.

In this embodiment, in order for the guide path in the map to be adjusted together with the map, each path point of the guide path in the map needs to be bound in advance with the key frame obtained at the corresponding path point in the operation scene to establish and store the transformation relationship between the two. When the loop of the map is detected, the pose corresponding to each key frame will be recalculated to obtain the new pose corresponding to the key frame. At this time, since each path point in the map maintains a certain relative position to the key frame, the path points in the map may also be adjusted accordingly, and eventually the map generated through the key frames may also be adjusted accordingly.

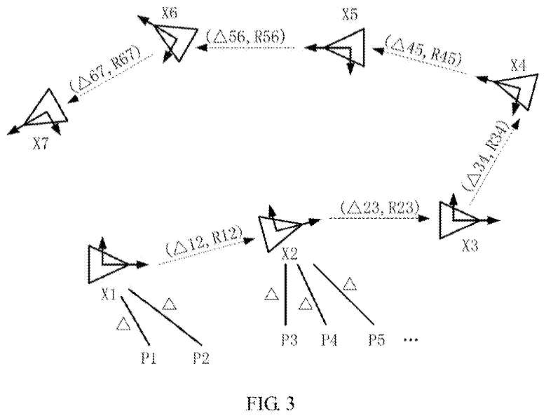

FIG. 3 is a schematic diagram of transformation relationships between key frames and path points according to an embodiment of the present disclosure. As shown in FIG. 3, the transformation relationship between the key frames and the path points in the map is exemplarily provided. In which, X1˜X7 represent key frames, P1˜P5 represent path points in the map, and Δij represents the transformation relationship between key frame i and key frame j. Rij represents the rotation matrix between key frame i and key frame j, Δ represents the transformation relationship between key frame Xi and the path point Pj in the map, and i and j are the numerical label for distinguishing different key frames or different path points in the map.

In one embodiment, after step S102, the method may further include:
removing noises from the guide path in the map.

In this embodiment, after generating the map including the guide path, the map may be processed to automatically clear the noises on the guide path in the map so as to avoid interference with subsequent operations of generating the operation points and the operation paths, thereby preventing the noises to be misidentified as part of the guide path in the map.
S103: generating a plurality of operation points on the guide path in the map.

In this embodiment, the operation points that operations have to be performed thereon may include a part or all of the path points on the guide path. When all of the path points are included, it means that on the entire guide path, the operations need to be performed. The operation points that the operations have to be performed thereon may be confirmed by the robot itself based on the map, or the user may input operation point setting instructions through the human-computer interaction equipment of the robot or the user terminal according to actual needs, so that the robot can learn the operation point that the operations have to be performed thereon, and generate these operation points that the operations have to be performed thereon on the guide path in the map.

In one embodiment, the robot may be a disinfection robot, and step S103 may include:
generating the plurality of operation points evenly on the guide path in the map at a preset interval.

In this embodiment, when the robot is the disinfection robot, in order to perform disinfection on the guide path in an even manner, a plurality of operation points may be generated in an even manner on the guide path in the map at the preset interval. The user may input interval setting instructions according to actual needs through the human-computer interaction equipment of the robot or the user terminal, so that the robot can learn the set interval of the operation points. The robot may also use a default preset interval of a system of the robot. The number of the operation points is equal to the total distance of the guide path divide by the preset interval.
S104: generating an operation path, where the operation path passes through all of the unpassed operation points and has a shortest total distance.

In this embodiment, in order to improve the efficiency of operations, it is necessary to generate the operation path that can pass through all the operation points and have the shortest total distance based on the locations of the operation points. Specifically, the operation path should make the total distance of the robot to start from the starting position and return after passing through all the operation points being the shortest, or the total distance of the robot to start from the starting position and reach the end position after passing through all the operation points being the shortest. The end position may be the location of a charging device of the robot, so that the robot can reach the location of the charging device to charge after completing all of the operations.

In one embodiment, the operation path may be generated using one of a Chinese Postman Problem (CPP) algorithm and a Traveling Salesman Problem (TSP) algorithm.

In this embodiment, the operation path may be generated through the CPP algorithm or the TSP algorithm, so that the total distance of the robot to start from the starting position and return to the starting point after passing through all the operation points being the shortest.
S105: moving the robot, according to the operation path, to each of the unpassed operation points so as to perform an operation.

In this embodiment, after generating the operation path, the robot may be moved to each unpassed operation point (the operation point that no operation is performed thereon) along the operation path so as to perform the operation such as sweeping, disinfection, handling, express delivery, and takeaway. After completing the operation at any operation point, the robot may regenerate the operation path that passes through all the remaining unpassed operation points and has the shortest total distance, and then be moved to the next operation point along the new operation path, and so on until the operation at the last operation point is completed.

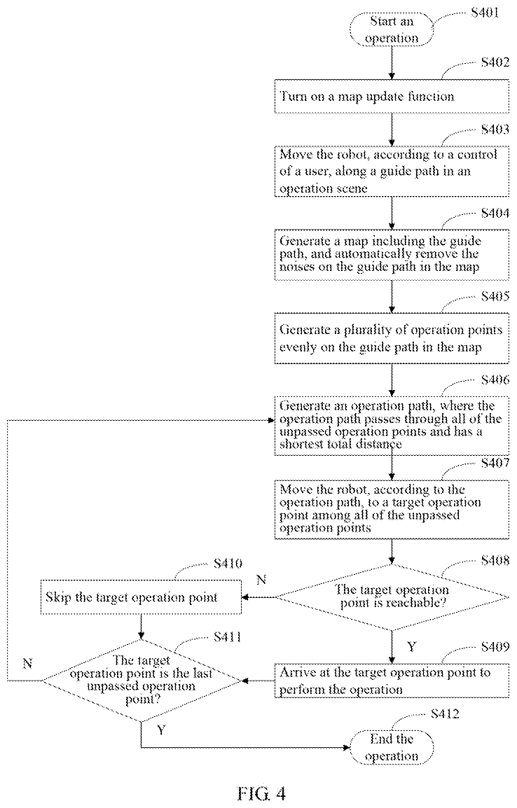

FIG. 4 is a flow chart of a robot autonomous operation method according to a third embodiment of the present disclosure. As shown in FIG. 4, in one embodiment, the robot autonomous operation method may include steps S401-S404.
S401: starting an operation, then proceed to step S402;
S402: turning on a map update function, then proceed to step S403;
S403: moving the robot, under a control of a user, along a guide path in an operation scene, then proceed to step S404;
S404: generating a map including the guide path, and automatically removing the noises on the guide path in the map, then proceed to step S405;
S405: generating a plurality of operation points evenly on the guide path in the map, then proceed to step S406;
S406: generating an operation path, where the operation path passes through all of the unpassed operation points and has a shortest total distance, then proceed to step S407;
S407: moving the robot, according to the operation path, to a target operation point among all of the unpassed operation points, then proceed to S408;
S408: determining whether the target operation point is reachable; if so (that is, the target operation point is reachable), proceed to step S409; otherwise (that is, the target operation point is unreachable), proceed to step S410;
S409: arriving at the target operation point to perform the operation, then proceed to step S411;
S410: skipping the target operation point, then proceed to step S411;
S411: determining whether the target operation point is the last unpassed operation point; if so (that is, the target operation point is the last unpassed operation point), proceed to step S412; otherwise (that is, the target operation point is not the last unpassed operation point), proceed to step S406.
S412: ending the operation.

In this embodiment, before using the manual guide method to control the robot to move along the guide path of the operation scene, the map update function of the robot needs to be enabled first, so that the robot can update the map using the SLAM technology during moving along the guide path.

In this embodiment, steps S407-S412 are sub-steps of step S105, and the target operation point is any unpassed operation point. The robot is moved to the K-th unpassed operation point along the operation path. If it can reach the K-th unpassed operation point along the operation path, it will be moved to the K-th unpassed operation point to perform the operation; otherwise, the K-th unpassed operation point will be skipped. Then, it returns to the step of generating the operation path, and regenerates the operation path that passes through all the remaining unpassed operation points and has the shortest total distance based on all the remaining unpassed operation points. Finally, it is moved to the K+1-th unpassed operation point along the new operation path, and so on until the operation on the last unpassed operation point is completed or the last unpassed operation point is skipped so as to end the operation. In which, K=1, 2, . . . , n−1, n is the number of all the unpassed operation points.

In this embodiment, if the robot cannot reach the target operation point according to the operation path, it means that there are new obstacles or channels on the path to the target operation point in the operation scene that the robot cannot cross. The new obstacles may be humans or objects newly appear on the path of the robot to move to the target operation point.

In this embodiment, the robot autonomous operation method controls the robot to explore the guide path in the operation scene by manual guiding, which can improve the exploration efficiency and reduce the risk of exploring unknown operation scenes. At the same time, a reasonable operation path planning is performed on the guide path, which can improve the operation efficiency, and is especially suitable for disinfection robots to perform disinfection operations.

It should be understood that, the sequence of the serial number of the steps in the above-mentioned embodiments does not mean the execution order while the execution order of each process should be determined by its function and internal logic, which should not be taken as any limitation to the implementation process of the embodiments.

In the present disclosure, a robot autonomous operating apparatus is also provided. This apparatus is applied to the robot and configured to execute the steps in the above-method method embodiments. This apparatus may be a virtual appliance in the robot that is executed by the processor of the robot, or be the robot itself,

FIG. 5 is a schematic block diagram of the structure of a robot autonomous operation apparatus 100 according to an embodiment of the present disclosure. As shown in FIG. 5, the robot autonomous operating apparatus 100 may include:
a motion module 101 configured to move the robot, under a control of a manual guide method performed by a user, along a guide path in an operation scene;
a positioning and mapping module 102 configured to generate a map including the guide path by positioning and mapping during the robot being moved along the guide path in the operation scene;
an operation point generating module 103 configured to generate a plurality of operation points on the guide path in the map;
an operation path generating module 104 configured to generate an operation path, where the operation path passes through all of the unpassed operation points and has a shortest total distance; and
an operation module 105 configured to move the robot, according to the operation path, to each of the unpassed operation points so as to perform an operation.

In one embodiment, the positioning and mapping module 102 may further configured to:
establish and store a transformation relationship between the position of each path point on the guide path in the map and the pose of the robot at the key frame of the map that is obtained at each path point;
update the pose of the robot at each key frame of the map and the position of each path point on the guide path in the map, in response to the loop of the map being detected includes:
update the pose of the robot at each key frame of the map, in response to the loop of the map being detected; and
update, according to the updated pose of the robot at each key frame of the map and the transformation relationship, the position of each path point on the guide path in the map.

In one embodiment, the positioning and mapping module 102 may further configured to:
establish and store a transformation relationship between the position of each path point on the guide path in the map and the pose of the robot at the key frame of the map that is obtained at each path point:
update the pose of the robot at each key frame of the map and the position of each path point on the guide path in the map, in response to the loop of the map being detected includes:
update the pose of the robot at each key frame of the map, in response to the loop of the map being detected; and
update, according to the updated pose of the robot at each key frame of the map and the transformation relationship, the position of each path point on the guide path in the map.

In one embodiment, the operation module 105 may further configured to:
move the robot, according to the operation path, to a target operation point among all of the unpassed operation points;
move the robot to the target operation point so as to perform the operation, in response to the target operation point being reachable;
skip the target operation point, in response to the target operation point being unreachable;
end the operation, in response to the target operation point being the last unpassed operation point; and
return to generating the operation path, in response to the target operation point being not the last unpassed operation point.

In this embodiment, each module in the above-mentioned apparatus may be a software program module, or may be implemented through different logical circuits integrated in the processor or independent physical components connected to the processor, or may be implemented through a plurality of distributed processors.

FIG. 6 is a schematic block diagram of a robot 200 according to an embodiment of the present disclosure. As shown in FIG. 6, in this embodiment, the robot 200 is also provided, which may include a positioning sensor 201, at least one processor 202 (only one processor is shown in FIG. 6), a storage 203, and a computer program 204 stored in the storage 203 and can be executed on the at least one processor 202. When the processor 202 executes the computer program 204, the steps in each of the above-mentioned embodiments of the robot autonomous operation method are implemented.

In this embodiment, the robot may include, but is not limited to, a positioning sensor, a processor and a storage. FIG. 6 is only an example of the robot and does not constitute a limitation on the robot, where more or fewer components than shown in the figure may be included, or certain components or different components may be combined, for example, it may further include an input and output device, a network access device, and the like. The input and output device may include the above-mentioned human-computer interaction equipment, and may also include a display screen for displaying the operation parameters of the robot, for example, the map. The network access device may include a communication module for the robot to communicate with the user terminal.

In this embodiment, the processor may be a central processing unit (CPU), which may also be other general-purpose processor, digital signal processor (DSP), application specific integrated circuit (ASIC), field-programmable gate array (FPGA), or other programmable logic device, discrete gate, transistor logic device, discrete hardware component, or the kike. A general-purpose processor may be a microprocessor, or the processor may be any conventional processor.

In this embodiment, the storage may be an internal storage unit of the robot, for example, a hard drive or a memory of the robot. In other embodiments, the storage may also be an external storage device of the robot, for example, a plug-in hard drive, a smart media card (SMC), a secure digital (SD) card, or a flash card that is equipped on the robot. The storage may also include both the internal storage units and the external storage devices of the robot. The storage may be configured to store operating systems, applications, boot loaders, data, and other programs such as codes of computer programs. The storage may also be configured to temporarily store data that has been output or will be output.

In this embodiment, the display screen may be a thin film transistor liquid crystal display (TFT-LCD), a liquid crystal display (LCD), an organic light-emitting diode (OLED) display, a quantum dot display (QLED), or the like.

In this embodiment, the communication module may be set according to actual needs as any device that can directly or indirectly conduct long-distance wired or wireless communications with the user terminal. For example, the communication module may provide communication solutions to be applied on network equipment that include wireless local area networks (WLAN) (e.g., Wi-Fi network), Bluetooth, Zigbee, mobile communication network, global navigation satellite system (GNSS), frequency modulation (FM), near field communication (NFC), infrared (tR), and the like. The communication module may include an antenna, which may have only one array element, or may be an antenna array including a plurality of array elements. The communication module may receive electromagnetic waves through the antenna, frequency modulate and filter the electromagnetic wave signals, and transmit the processed signals to the processor. The communication module may also receive the to-be-transmitted signals from the processor to frequency modulate and amplify, and convert into electromagnetic waves through the antenna for radiation.

It should be noted that the information interactions, execution processed, and the like between the above-mentioned devices/modules are based on the same concept as the method embodiments of the present disclosure, and their specific functions and technical effects can be found in the part of the method embodiments, which will not be described herein.

Those skilled in the art may clearly understand that, for the convenience and simplicity of description, the division of the above-mentioned functional modules is merely an example for illustration. In actual applications, the above-mentioned functions may be allocated to be performed by different functional modules according to requirements, that is, the internal structure of the device may be divided into different functional modules or modules to complete all or part of the above-mentioned functions. The functional modules in the embodiments may be integrated in one processing module, or each module may exist alone physically, or two or more modules may be integrated in one module. The above-mentioned integrated module may be implemented in the form of hardware or in the form of software functional module. In addition, the specific name of each functional module and module is merely for the convenience of distinguishing each other and are not intended to limit the scope of protection of the present disclosure. For the specific operation process of the modules in the above-mentioned system, reference may be made to the corresponding processes in the above-mentioned method embodiments, and are not described herein.

The present disclosure further provides a computer-readable storage medium. The computer-readable storage medium is stored with a computer program. When the computer program is executed by a processor, the steps in each of the above-mentioned method embodiments can be implemented.

The present disclosure further provides a computer program product. When the computer program product is executed on the robot, the robot can implement the steps in the above-mentioned method embodiments.

When the integrated module is implemented in the form of a software functional module and is sold or used as an independent product, the integrated module may be stored in a non-transitory computer-readable storage medium. Based on this understanding, all or part of the processes in the method for implementing the above-mentioned embodiments of the present disclosure are implemented, and may be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include at least any entity or device, a recording medium, a computer memory, a read-only memory (ROM), a random access memory (RAM), electric carrier signals, telecommunication signals and software distribution media that is capable of carrying the computer program codes on the robot, for example, a USB flash drive, a portable hard disk, a magnetic disk, an optical disk, or the like.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative modules and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device) and method may be implemented in other manners. For example, the above-mentioned apparatus embodiment is merely exemplary. For example, the division of modules is merely a logical functional division, and other division manner may be used in actual implementations, that is, multiple modules or components may be combined or be integrated into another system, or some of the features may be ignored or not performed. In addition, the shown or discussed mutual coupling may be direct coupling or communication connection, and may also be indirect coupling or communication connection through some interfaces, devices or modules, and may also be electrical, mechanical or other forms.

The modules described as separate components may or may not be physically separated. The components represented as modules may or may not be physical modules, that is, may be located in one place or be distributed to multiple network modules. Some or all of the modules may be selected according to actual needs to achieve the objectives of this embodiment.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented autonomous operation method for a robot, comprising:
moving the robot, under a control of a manual guide method performed by a user, along a guide path in an operation scene;
generating a map including the guide path by positioning and mapping during the robot being moved along the guide path in the operation scene;
generating a plurality of operation points on the guide path in the map;
generating an operation path, wherein the operation path passes through all of the unpassed operation points and has a shortest total distance; and
moving the robot, according to the operation path, to each of the unpassed operation points so as to perform an operation.

2. The method of claim 1, wherein generating the map including the guide path by positioning and mapping during the robot being moved along the guide path in the operation scene includes:
obtaining, through a positioning sensor of the robot, positioning data during the robot being moved along the guide path in the operation scene, wherein the positioning sensor includes a dual laser radar; and
generating the map including the guide path by processing the positioning data using a simultaneous localization and mapping technology.

3. The method of claim 1, wherein the robot is a disinfection robot, and generating the plurality of operation points on the guide path in the map includes:
generating the plurality of operation points evenly on the guide path in the map at a preset interval.

4. The method of claim 1, wherein generating the operation path includes:
generating the operation path using one of a Chinese Postman Problem algorithm and a Traveling Salesman Problem algorithm.

5. The method of claim 1, wherein after generating the map including the guide path by positioning and mapping during the robot being moved along the guide path in the operation scene, further comprising:
removing noises from the guide path in the map.

6. The method of claim 1, wherein moving the robot, according to the operation path, to each of the unpassed operation points so as to perform the operation includes:
moving the robot, according to the operation path, to a target operation point among all of the unpassed operation points;
moving the robot to the target operation point so as to perform the operation, in response to the target operation point being reachable;
skipping the target operation point, in response to the target operation point being unreachable;
ending the operation, in response to the target operation point being the last unpassed operation point; and
returning to generating the operation path, in response to the target operation point being not the last unpassed operation point.

7. The method of claim 1, wherein after generating the map including the guide path by positioning and mapping during the robot being moved along the guide path in the operation scene, further comprising:
updating a pose of the robot at each key frame of the map and a position of each path point on the guide path in the map, in response to a loop of the map being detected.

8. The method of claim 7, wherein before updating the pose of the robot at each key frame of the map and the position of each path point on the guide path in the map, in response to the loop of the map being detected, further comprising:
establishing and storing a transformation relationship between the position of each path point on the guide path in the map and the pose of the robot at the key frame of the map that is obtained at each path point;
updating the pose of the robot at each key frame of the map and the position of each path point on the guide path in the map, in response to the loop of the map being detected includes:
updating the pose of the robot at each key frame of the map, in response to the loop of the map being detected; and
updating, according to the updated pose of the robot at each key frame of the map and the transformation relationship, the position of each path point on the guide path in the map.

9. The method of claim 1, wherein the manual guide method includes at least one of:
receiving, by the robot, a force from a user for moving the robot along the guide path in the operation scene;
receiving, through a human-computer interaction equipment of the robot, a motion control instruction input by the user for moving the robot along the guide path in the operation scene according to the motion control instruction; and
receiving, by the robot, a motion control instruction from a user terminal for moving the robot along the guide path in the operation scene according to the motion control instruction.

10. A robot, comprising:
a processor;
a memory coupled to the processor; and
one or more computer programs stored in the memory and executable on the processor;
wherein, the one or more computer programs comprise:
instructions for moving the robot, under a control of a manual guide method performed by a user, along a guide path in an operation scene;
instructions for generating a map including the guide path by positioning and mapping during the robot being moved along the guide path in the operation scene;
instructions for generating a plurality of operation points on the guide path in the map;
instructions for generating an operation path, wherein the operation path passes through all of the unpassed operation points and has a shortest total distance; and
instructions for moving the robot, according to the operation path, to each of the unpassed operation points so as to perform an operation.

11. The robot of claim 10, wherein generating the map including the guide path by positioning and mapping during the robot being moved along the guide path in the operation scene includes:
obtaining, through a positioning sensor of the robot, positioning data during the robot being moved along the guide path in the operation scene, wherein the positioning sensor includes a dual laser radar; and
generating the map including the guide path by processing the positioning data using a simultaneous localization and mapping technology.

12. The robot of claim 10, wherein the robot is a disinfection robot, and generating the plurality of operation points on the guide path in the map includes:
generating the plurality of operation points evenly on the guide path in the map at a preset interval.

13. The robot of claim 10, wherein generating the operation path includes:
generating the operation path using one of a Chinese Postman Problem algorithm and a Traveling Salesman Problem algorithm.

14. The robot of claim 10, wherein after generating the map including the guide path by positioning and mapping during the robot being moved along the guide path in the operation scene, further comprising:
removing noises from the guide path in the map.

15. The robot of claim 10, wherein moving the robot, according to the operation path, to each of the unpassed operation points so as to perform the operation includes:
moving the robot, according to the operation path, to a target operation point among all of the unpassed operation points;
moving the robot to the target operation point so as to perform the operation, in response to the target operation point being reachable;
skipping the target operation point, in response to the target operation point being unreachable;
ending the operation, in response to the target operation point being the last unpassed operation point, and
returning to generating the operation path, in response to the target operation point being not the last unpassed operation point.

16. The robot of claim 10, wherein after generating the map including the guide path by positioning and mapping during the robot being moved along the guide path in the operation scene, further comprising:
updating a pose of the robot at each key frame of the map and a position of each path point on the guide path in the map, in response to a loop of the map being detected.

17. The robot of claim 16, wherein before updating the pose of the robot at each key frame of the map and the position of each path point on the guide path in the map, in response to the loop of the map being detected, further comprising:
establishing and storing a transformation relationship between the position of each path point on the guide path in the map and the pose of the robot at the key frame of the map that is obtained at each path point:
updating the pose of the robot at each key frame of the map and the position of each path point on the guide path in the map, in response to the loop of the map being detected includes:
updating the pose of the robot at each key frame of the map, in response to the loop of the map being detected; and
updating, according to the updated pose of the robot at each key frame of the map and the transformation relationship, the position of each path point on the guide path in the map.

18. The robot of claim 10, wherein the manual guide method includes at least one of:
receiving, by the robot, a force from a user for moving the robot along the guide path in the operation scene;
receiving, through a human-computer interaction equipment of the robot, a motion control instruction input by the user for moving the robot along the guide path in the operation scene according to the motion control instruction; and
receiving, by the robot, a motion control instruction from a user terminal for moving the robot along the guide path in the operation scene according to the motion control instruction.

19. A non-transitory computer-readable storage medium for storing one or more computer programs, wherein the one or more computer programs comprise:
instructions for moving a robot, under a control of a manual guide method performed by a user, along a guide path in an operation scene;
instructions for generating a map including the guide path by positioning and mapping during the robot being moved along the guide path in the operation scene;
instructions for generating a plurality of operation points on the guide path in the map;
instructions for generating an operation path, wherein the operation path passes through all of the unpassed operation points and has a shortest total distance; and
instructions for moving the robot, according to the operation path, to each of the unpassed operation points so as to perform an operation.

20. The storage medium of claim 19, wherein the manual guide method includes at least one of:
receiving, by the robot, a force from a user for moving the robot along the guide path in the operation scene;
receiving, through a human-computer interaction equipment of the robot, a motion control instruction input by the user for moving the robot along the guide path in the operation scene according to the motion control instruction; and
receiving, by the robot, a motion control instruction from a user terminal for moving the robot along the guide path in the operation scene according to the motion control instruction.
